(19) United States
(12) Patent Application Publication
(10) Pub. No.: US 2026/0369195 A1
(43) Pub. Date: Nov. 19, 2026

(54) DISPLAY DEVICE AND ELECTRONIC DEVICE

(71) Applicant: Samsung Display Co., Ltd., Yongin-si (KR)

(72) Inventors: Seong Joo LEE, Yongin-si (KR); Jae Sang KIM, Yongin-si (KR)

(21) Appl. No.: 19/459,238

(22) Filed: Jan. 26, 2026

(30) Foreign Application Priority Data
May 14, 2025 (KR) 10-2025-0062766

(51) Int. Cl. G09G 3/00; G09G 3/3233

(52) U.S. Cl. CPC G09G 3/006; G09G 3/3233; G09G 2330/028; G09G 2330/04; G09G 2330/12

(57) ABSTRACT

A display device includes: pixels; output pads adjacent to the pixels; input pads spaced apart from the output pads; illumination pads between the output pads and the input pads, and comprising an illumination control pad and an illumination input pad; a first resistor connected to the illumination control pad; a first voltage providing circuit configured to provide a first voltage; and a first switch circuit configured to, based on a signal applied to the illumination control pad, connect the illumination input pad to a first output pad of the output pads, or connect the illumination input pad to the first voltage providing circuit.

### CROSS REFERENCE TO RELATED APPLICATION

The present application claims priority to and the benefit of Korean Patent Application No. 10-2025-0062766, filed on May 14, 2025, in the Korean Intellectual Property Office, the entire disclosure of which is incorporated herein by reference.

### BACKGROUND

### Field

Aspects of some embodiments of the present disclosure relate to a display device and an electronic device including the same.

### Description of the Related Art

With the development of information technology, the importance of display devices that operate as a connection medium between users and information is becoming increasingly important. In response to this, the use of display devices such as liquid crystal display devices, organic light emitting display devices, and the like is increasing.

The display panel of the display device may desirably be checked for proper lighting behavior before the integrated circuit is attached. Accordingly, the display panel may include illumination pads. The illumination pads may be contacted by probes for applying an illumination signal.

After the lighting inspection, unnecessary illumination pads may be cut and removed. However, there may be a risk of cracking the display panel due to the cutting process.

The above information disclosed in this Background section is only for enhancement of understanding of the background and therefore the information discussed in this Background section does not necessarily constitute prior art.

### SUMMARY

Aspects of some embodiments of the present disclosure include a display device and an electronic device including illumination pads that may be utilized without being cut off after a light inspection.

A display device according to some embodiments of the present invention includes: pixels; output pads positioned adjacent to the pixels; input pads spaced apart from the output pads; illumination pads located between the output pads and the input pads, and including an illumination control pad and an illumination input pad; a first resistor connected to the illumination control pad; a first voltage providing circuit configured to provide a first voltage; and a first switch circuit configured to, based on a signal applied to the illumination control pad, connect the illumination input pad to a first output pad of the output pads, or connect the illumination input pad to the first voltage providing circuit.

According to some embodiments, w the first switch circuit connects the illumination input pad to the first voltage providing circuit, the illumination control pad may be in a pulled-down state through the first resistor.

According to some embodiments, the display device may further include: a driver integrated circuit electrically connected to at least some of the output pads and at least some of the input pads, and covering the illumination pads.

According to some embodiments, the illumination pads may further include a first illumination pad. The display device may further include: a second resistor connected to the first illumination pad; a second voltage providing circuit configured to provide a second voltage; and a second switch circuit configured to, based on a signal applied to the first illumination pad, connect a target circuit to the first output pad, or connect the target circuit to the second voltage providing circuit.

According to some embodiments, the illumination pads may further include a second illumination pad. According to some embodiments, the display device may

further include: a third voltage providing circuit configured to provide a third voltage to the second illumination pad.

According to some embodiments, when the second switch circuit connects the target circuit to the second voltage providing circuit, the first illumination pad may be in a pulled-down state through the second resistor.

According to some embodiments, the display device may further include: a driver integrated circuit including output terminals electrically connected to at least some of the output pads, input terminals electrically connected to at least some of the input pads, a first illumination terminal electrically connected to the first illumination pad, and a second illumination terminal electrically connected to the second illumination pad.

According to some embodiments, the driver integrated circuit may further include a conductive line connecting the first illumination terminal and the second illumination terminal.

According to some embodiments, the second illumination pad and the first illumination pad may be electrically connected via the second illumination terminal, the conductive line, and the first illumination terminal.

According to some embodiments, when the second illumination pad and the first illumination pad are electrically connected, the first output terminal may be connected to the target circuit via the second switch circuit.

An electronic device according to some embodiments of the present invention includes: a processor configured to provide image data; and a display device configured to display an image based on the image data, wherein the display device includes: pixels; output pads located adjacent to the pixels; input pads spaced apart from the output pads; illumination pads located between the output pads and the input pads, and including an illumination control pad and an illumination input pad; a first resistor connected to the illumination control pad; a first voltage providing circuit configured to provide a first voltage; and a first switch circuit configured to,

based on a signal applied to the illumination control pad, connect the illumination input pad to a first output pad of the output pads, or connect the illumination input pad to the first voltage providing circuit.

According to some embodiments, when the first switch circuit connects the illumination input pad to the first voltage providing circuit, the illumination control pad may be in a pulled-down state through the first resistor.

According to some embodiments, the display device may further include: a driver integrated circuit electrically connected to at least some of the output pads and at least some of the input pads, and covering the illumination pads.

According to some embodiments, the illumination pads may further include a first illumination pad. According to some embodiments, the display device may further include: a second resistor connected to the first illumination pad; a second voltage providing circuit configured to provide a second voltage; and a second switch circuit configured to, based on a signal applied to the first illumination pad, connect a target circuit to the first output pad, or connect the target circuit to the second voltage providing circuit.

According to some embodiments, the illumination pads may further include a second illumination pad. The display device may further include: a third voltage providing circuit configured to provide a third voltage to the second illumination pad.

According to some embodiments, when the second switch circuit connects the target circuit to the second voltage providing circuit, the first illumination pad may be in a pulled-down state through the second resistor.

According to some embodiments, the display device may further include: a driver integrated circuit including output terminals electrically connected to at least some of the output pads, input terminals electrically connected to at least some of the input pads, a first illumination terminal electrically connected to the first illumination pad, and a second illumination terminal electrically connected to the second illumination pad.

According to some embodiments, the driver integrated circuit may further include a conductive line connecting the first illumination terminal and the second illumination terminal.

According to some embodiments, the second illumination pad and the first illumination pad may be electrically connected via the second illumination terminal, the conductive line, and the first illumination terminal.

According to some embodiments, when the second illumination pad and the first illumination pad are electrically connected, the first output terminal may be connected to the target circuit via the second switch circuit.

### BRIEF DESCRIPTION OF THE DRAWINGS

The above and other aspects of some embodiments of the present disclosure will become more apparent by describing in further detail aspects of some embodiments thereof with reference to the accompanying drawings, in which:

FIG. 1 is a block diagram illustrating aspects of a display device according to some embodiments.

FIG. 2 is a block diagram illustrating aspects of one of the sub-pixels of FIG. 1 according to some embodiments.

FIG. 3 is a plane view illustrating aspects of the display panel of FIG. 1 according to some embodiments.

FIG. 4 is a plane view illustrating aspects of a driver integrated circuit and circuit board attached to the display panel according to some embodiments.

FIGS. 5 and 6 are drawings to illustrate the relationship between an illumination input pad, an illumination control pad, and a first output pad, according to some embodiments of the present invention.

FIG. 7 is a diagram to illustrate aspects of a first switch circuit and a first voltage providing circuit according to some embodiments.

FIG. 8 illustrates aspects of a relationship between an illumination input pad, an illumination control pad, a first output pad, a first illumination pad, and a second illumination pad, according to some embodiments of the present invention.

FIG. 9 is a drawing to illustrate a driver integrated circuit according to some embodiments of the present invention.

FIG. 10 is a drawing to illustrate the relationship between an illumination input pad, an illumination control pad, a first output pad, a first illumination pad, and a second illumination pad, according some embodiments of the present invention.

FIG. 11 is a drawing to illustrate a driver integrated circuit according to some embodiments of the present invention.

FIG. 12 is a drawing to illustrate a driver integrated circuit according to some embodiments of the present invention.

FIG. 13 is a drawing to illustrate aspects of a second switch circuit, a second voltage providing circuit, and a third voltage providing circuit according to some embodiments.

FIG. 14 is a block diagram of an electronic device, according to some embodiments.

FIG. 15 is a diagram illustrating embodiments of an electronic device.

### DETAILED DESCRIPTION

Hereinafter, with reference to the accompanying drawings, aspects of some embodiments of the present invention will be described in more detail to facilitate practice by one having ordinary skill in the art to which the invention belongs. The invention may be implemented in many different forms and is not limited to the embodiments described herein.

In order to clearly illustrate the invention, description of some parts not pertinent to the description may be omitted, and identical or similar components are

designated by the same reference numerals throughout the specification. Accordingly, the aforementioned reference numerals may be used in other drawings.

Further, the size and thickness of each configuration shown in the drawings is arbitrarily indicated for ease of illustration and the invention is not necessarily limited to that shown. Thicknesses may be exaggerated in the drawings to clearly represent different layers and regions.

In addition, when the term "identical" is used in the description, it is intended to mean "substantially identical," i.e., identical to the extent that a person of ordinary skill in the art would be satisfied that they are identical. Other expressions may also include expressions where "substantially" is omitted.

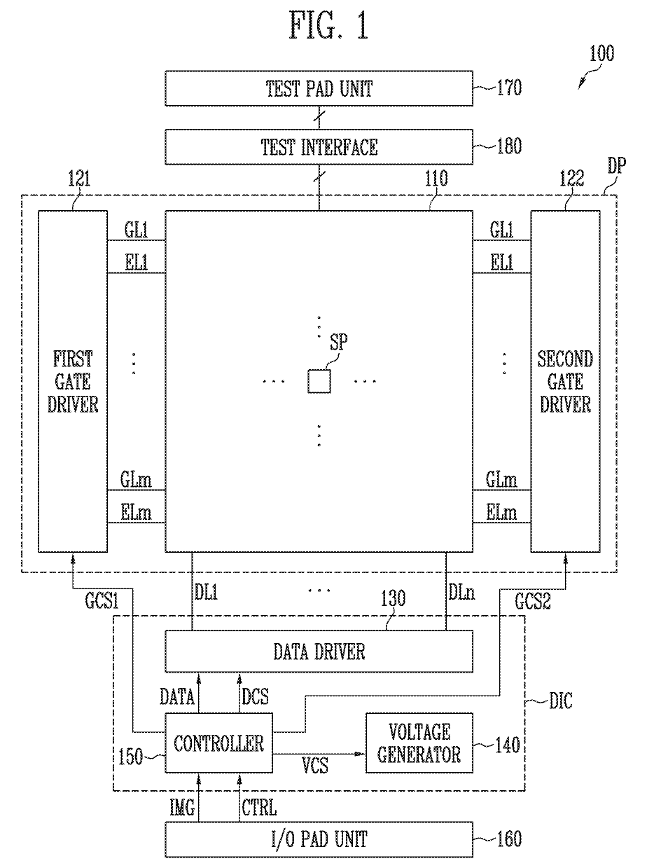

FIG. 1 is a block diagram illustrating aspects of a display device 100 according to some embodiments. Although FIG. 1 illustrates various components in a display device according to some embodiments, embodiments according to the present disclosure are not limited thereto, and according to various embodiments the display device may include additional components, or fewer components, without departing from the spirit and scope of embodiments according to the present disclosure.

Referring to FIG. 1, the display device 100 may include a display portion 110, first and second gate drivers 121, 122, a data driver 130, a voltage generator 140, a controller 150, and an input/output pad unit 160.

The display portion 110 includes sub-pixels SP. Although FIG. 1 illustrates a single sub-pixel SP for convenience of illustration, as a person having ordinary skill in the art would appreciate, the display device 100 may include any suitable number of sub-pixels SP according to the design and size of the display device 100. The sub-pixels SP may be arranged in a zigzag pattern along the row and column directions. For example, the sub-pixels SPs may be arranged in a PENTILE^{TM} pattern. However, embodiments according to the present disclosure are not limited

thereto. For example, the sub-pixels SP may be arranged in a matrix along the row and column directions.

The sub-pixels SP may be connected to the first and second gate drivers 121, 122 via the first to m-th gate lines GL1 to GLm. The sub-pixels SP may be connected to the data driver 130 via first to n-th data lines DL1 to DLn.

Each of the sub-pixels SP may include at least one light emitting element configured to generate light. Accordingly, each of the sub-pixels SP may be capable of generating light of a particular color, such as red, green, blue, cyan, magenta, yellow, or the like. A unit of two or more sub-pixels may be provided as a single pixel. Accordingly, a pixel may emit light of various colors. As such, the display device 100 displays the image through the display portion 110.

According to some embodiments, the display portion 110 may have a variety of shapes. The display portion may have the shape of a closed loop that includes straight and/or curved sides. For example, the display portion 110 may have the shape of a polygon, circle, semicircle, ellipse, or the like.

The display portion 110 may be used as a display screen for a Virtual Reality (VR) device, a Mixed Reality (MR) device, an Augmented Reality (AR) device, or the like. For example, the display portion 110 may be used as a display screen for a head-mounted display. In such cases, a relatively high density of sub-pixels SP is required. To increase the integration of the sub-pixels, the sub-pixels may be formed on a silicon substrate. The display device 100 including the sub-pixels SP formed on the silicon substrate may be referred to as an OLEDoS (OLED on Silicon) display device.

The first gate driver 121 may be connected to the sub-pixels SP arranged in the row direction via the first to m-th gate lines GL1 to GLm. The second gate driver 122 may be connected to the sub-pixels SP arranged in the row direction via the first to m-th gate lines GL1 to GLm. However, embodiments are not limited to this. The first and second gate drivers 121, 122 may be connected to different gate

lines. For example, the first gate driver 121 may be connected to an odd number of gate lines and the second gate driver 122 may be connected to an even number of gate lines.

Each of the first and second gate drivers 121, 122 may operate in response to control from the controller 150. The first gate driver 121 may output gate signals to the first to m-th gate lines GL1 to GLm in response to a first gate control signal GCS1 from the controller 150. The second gate driver 122 may output gate signals to the first to m-th gate lines GL1 to GLm in response to a second gate control signal GCS2 from the controller 150. According to some embodiments, each of the first and second gate control signals GCS1, GCS2 may include a start signal to indicate the start of each frame, a horizontal synchronization signal for outputting gate signals in synchronization with the timing of data signals being applied, and the like.

Further first to m-th emission control lines EL1 to ELm may be provided that are connected to the sub-pixels SP in the row direction. In such cases, each of the first and second gate drivers 121, 122 may include a light emission control driver configured to control the first to m-th light emission control lines EL1 to ELm under control of the controller 150. However, embodiments according to the present disclosure are not limited thereto. For example, the light emission control drivers of the first gate driver 121 may be coupled to the odd numbered light emission control lines, and the light emission control drivers of the second gate driver 122 may be coupled to the even numbered light emission control lines.

The first gate driver 121 may be located on one side of the display portion 110, and the second gate driver 122 may be located on the other side of the display portion 110. However, embodiments are not limited to this. For example, the display device 100 may include only one gate driver located on one side of the display portion 110.

The display portion 110 and the first and second gate drivers 121, 122 may be formed within a display panel DP. The display portion 110 may be located in a display area of the display panel DP. Accordingly, the display panel DP may display an image through the display area. The first and second gate drivers 121, 122 may be located in a non-display area of the display panel DP around the display area. However, embodiments according to the present disclosure are not limited to this. More components may be included within the display panel DP. For example, the display panel DP may further include at least one of a driver integrated circuit DIC, an input/output pad unit 160, a test pad unit 170, or a test interface 180 in the non-display area.

According to some embodiments, the display area of the display panel DP may be flat. According to some embodiments, the display area of the display panel DP may have at least a partially rounded shape. According to some embodiments, the display panel DP may be bendable, foldable, or rollable. In such cases, the display panel DP may include a material having flexible properties.

The data driver 130 is connected to the sub-pixels SP arranged in a columnwise direction via the first to n-th data lines DL1 to DLn. The data driver 130 receives image data DATA and data control signals DCS from the controller 150. The data driver 130 operates in response to the data control signals DCS. According to some embodiments, the data control signal DCS may include a source start pulse, a source shift clock, a source output enable signal, and the like.

Using voltages from the voltage generator 140, the data driver 130 may apply data signals having grayscale voltages corresponding to the image data DATA to the first to n-th data lines DL1 to DLn. When a gate signal is applied to each of the first to m-th gate lines GL1 to GLm, data signals corresponding to the image data DATA may be applied to the data lines DL1 to DLm. Accordingly, the corresponding sub-pixels SP may generate light corresponding to the data signals. Accordingly, the image is displayed on the display portion 110.

According to some embodiments, the first and second gate drivers 121, 122, and the data driver 130 may include complementary metal-oxide semiconductor (CMOS) circuit elements.

According to some embodiments, a demux circuit may be provided between the data driver 130 and the display 110. The demux circuit may demultiplex the data signals from the data driver 130 and output them to the first to n-th data lines DL1 to DLn.

The voltage generator 140 may be operable in response to a voltage control signal VCS from the controller 150. The voltage generator 140 may receive an external voltage via the input/output pad unit 160 and may generate a plurality of voltages using the received external voltage. The generated plurality of voltages may be provided to components of the display device 100. According to some embodiments, some of the voltages provided to the components of the display device 100 may be voltages received via the input/output pad unit 160.

The controller 150 controls various operations of the display device 100. The controller 150 receives input image data IMG and a control signal CTRL for controlling the input image data IMG from an external source via the input/output pad unit 160. In response to the control signal CTRL, the controller 150 may provide first and second gate control signals GCS1, GCS2, a data control signal DCS, and a voltage control signal VCS.

The controller 150 may convert the input image data IMG to be suitable for the display device 100 or display portion 110 to output image data DATA. According to some embodiments, the controller 150 may output the image data DATA by aligning the input image data IMG to adapt to the sub-pixels SP in a row unit.

According to some embodiments, the display device 100 may further include a temperature sensor. The controller 150 may receive temperature data from the temperature sensor and may control components of the display device 100 based on the received temperature data.

Two or more components of the data driver 130, voltage generator 140, and controller 150 may be mounted on a single integrated circuit. As shown in FIG. 1, the data driver 130, voltage generator 140, and controller 150 may be included in a driver integrated circuit DIC. In such cases, the data driver 130, voltage generator 140, and controller 150 may be functionally distinct components within a single driver integrated circuit DIC. According to some embodiments, the driver integrated circuit DIC may further include first and second gate drivers 121, 122. According to some embodiments, at least one of the first and second gate drivers 121, 122, the data driver 130, the voltage generator 140, or the controller 150 may be provided as a component separate from the driver integrated circuit DIC.

The input/output pad unit 160 may include a plurality of pads. Each of the plurality of pads may receive signals or voltages from an external source. As such, the input/output pad unit 160 may receive signals and voltages from an external source and transfer the received signals and voltages to components of the display device 100. For example, the input/output pad unit 160 may include pads for receiving input image data IMG and control signals CTRL. For example, the input/output pad unit 160 may include pads for receiving voltages.

The display device 100 may further include a test pad unit 170 and a test interface 180. The test pad unit 170 may include a plurality of pads.

The pads of the test pad unit 170 may receive signals for testing from the sub-pixels SP via a test interface 180. According to some embodiments, test interface 180 may include a mux circuit. When a test module is connected to the pads of the test pad unit 170, the test module may receive test signals from the sub-pixel SP via the test pad unit 170 and the test interface 180 to test whether the sub-pixel SP are not abnormal. As another example, to measure the luminance of light emitted by the sub-pixels, the test module may apply test signals to the sub-pixels SP via the test pad unit 170 and the test interface 180. In addition, the test module connected to the test pad unit 170 may receive signals from components of the

display device 100 and/or apply signals to components of the display device 100 for various purposes.

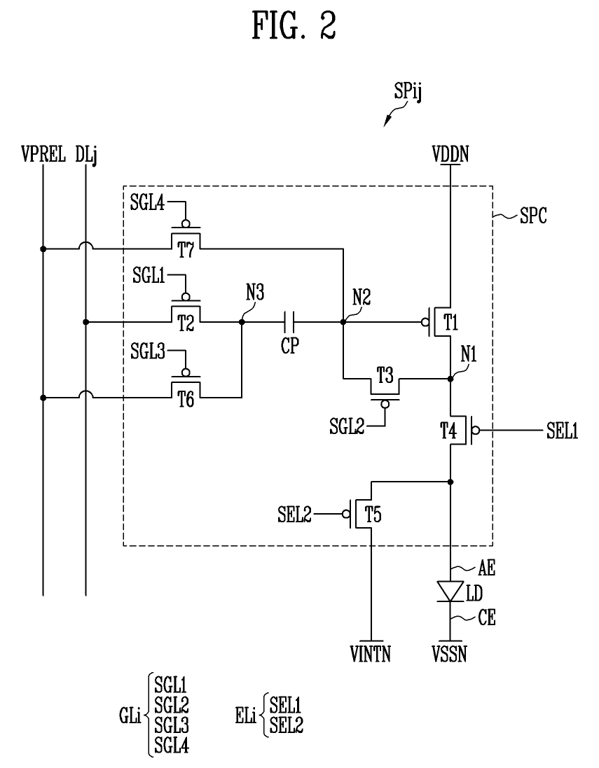

FIG. 2 is a block diagram illustrating aspects of one of the sub-pixels SP of FIG. 1 according to some embodiments. Although FIG. 2 illustrates various components in a sub-pixel SP according to some embodiments, embodiments according to the present disclosure are not limited thereto, and according to various embodiments the sub-pixel SP may include additional components, or fewer components, without departing from the spirit and scope of embodiments according to the present disclosure.

In FIG. 2, a sub-pixel SPij of the sub-pixels SP of FIG. 1 arranged in an i-th row (where i is an integer greater than or equal to 1 and less than or equal to m) and a j-th column (where j is an integer greater than or equal to 1 and less than or equal to n) is illustrated as an example.

Referring to FIG. 2, the sub-pixel SPij may include a sub-pixel circuit SPC and a light emitting element LD.

The anode electrode AE of the light emitting element LD may be connected to the first power supply voltage node VDDN via the sub-pixel circuit SPC, and the cathode electrode CE of the light emitting element LD may be connected to the second power supply voltage node VSSN. In this case, the first power supply voltage node VDDN is a node carrying a first power supply voltage, and the second power supply voltage node VSSN is a node carrying a second power supply voltage. The first power supply voltage has a higher level than the second power supply voltage. The first and second power supply voltages may be provided by the voltage generator 140 of FIG. 1. However, embodiments according to the present disclosure are not limited thereto. At least one of the first or second power supply voltages may be provided from an external device via the input/output pad unit 160 of FIG. 1.

The sub-pixel circuit SPC may be connected to the i-th gate line GLi of the first to m-th gate lines GL1 to GLm of FIG. 1, the i-th emission control line ELi of the

first to m-th emission control lines EL1 to ELm of FIG. 1, and the j-th data line DLj of the first to n-th data lines DL1 to DLn of FIG. 1. The sub-pixel circuit SPC is configured to control the light emitting element LD according to signals received via these signal lines.

The i-th gate line GLi may include first to fourth sub-gate lines SGL1 to SGL4. The sub-pixel circuit SPC may operate in response to gate signals received via the first to fourth sub-gate lines SGL1 to SGL4. However, embodiments are not limited thereto. The i-th gate line GLi may include one or more sub-gate lines.

The i-th emission control line ELi may include first and second sub-emission control lines SEL1, SEL2. The sub-pixel circuit SPC may operate in response to light emission control signals received via the first and second sub-light emission control lines SEL1, SEL2. However, embodiments are not limited thereto. The i-th emission control line ELi may include one or more sub-emission control lines.

The sub-pixel circuit SPC may receive the data signal via the j-th data line DLj. The sub-pixel circuitry SPC may store a voltage corresponding to the data signal in response to a gate signal received via at least one of the first to fourth sub-gate lines SGL1 to SGL4. In response to a light emission control signal received via at least one of the first or second sub-light emission control lines SEL1, SEL2, the sub-pixel circuit SPC may adjust the current flowing from the first power supply voltage node VDDN to the second power supply voltage node VSSN through the light emitting element LD according to the stored voltage. Accordingly, the light emitting element LD may generate light of a luminance corresponding to the data signal.

According to some embodiments, the sub-pixel circuit SPC may include first to seventh transistors T1 to T7 and a capacitor CP.

The first transistor T1 is connected between the first power supply voltage node VDDN and the first node N1. The gate of the first transistor T1 may be

connected to the second node N2. The second transistor T2 is connected between the j-th data line DLj and the third node N3. The gate of the second transistor T2 may be connected to the first sub-gate line SGL1. The third transistor T3 is connected between the first node N1 and the second node N2. The gate of the third transistor T3 may be connected to the second sub-gate line SGL2. The fourth transistor T4 is connected between the first node N1 and the anode electrode AE. The gate of the fourth transistor T4 may be connected to the first sub-emission control line SEL1.

The fifth transistor T5 is connected between the anode electrode AE and the initialization voltage node VINTN. The initialization voltage node VINTN is configured to deliver an initialization voltage, which is a direct current voltage. According to some embodiments, the initialization voltage may be provided by the voltage generator 140 of FIG. 1. According to some embodiments, the initialization voltage may be provided from an external device via the input/output pad unit 160 of FIG. 1. The gate of the fifth transistor T5 may be connected to the second sub-emission control line SEL2. When the fifth transistor T5 is turned on, the anode electrode AE may be initialized with the initialization voltage.

One end of the capacitor CP is connected to the second node N2, and the other end of the capacitor CP is connected to the third node N3.

The sixth transistor T6 is connected between the pre-voltage line VPREL and the third node N3. The pre-voltage line VPREL is configured to carry a pre-voltage, which is a direct current voltage. According to some embodiments, the pre-voltage may be provided by the voltage generator 140 of FIG. 1. According to some embodiments, the pre-voltage may be provided by an external device via the input/output pad unit 160 of FIG. 1. The sixth transistor T6 may be turned on in response to a gate signal from the third sub-gate line SGL3. When the sixth transistor T6 is turned on, the third node N3 may be initialized to the pre-voltage.

The seventh transistor T7 is connected between the pre-voltage line VPREL and the second node N2. The seventh transistor T7 may be turned on in

response to a gate signal of the fourth sub-gate line SGL4. When the seventh transistor T7 is turned on, the second node N2 may be initialized to the pre-voltage.

According to some embodiments, the first to seventh transistors T1 to T7 may have a body bias voltage (or substrate bias voltage) applied to them. For example, a first power supply voltage, which is the voltage applied to the first power supply voltage node VDDN, may be commonly applied to the bodies of the first to seventh transistors T1 to T7. However, embodiments according to the present disclosure are not limited thereto. The body biases applied to the first to seventh transistors T1 to T7 may be varied.

In addition, the sub-pixel circuit SPC may be implemented as any of various types of circuits including a plurality of transistors and one or more capacitors. Depending on the embodiment of the sub-pixel circuit SPC, the number of sub-gate lines included in the i-th gate line GLi and the number of sub-emission control lines included in the i-th emission control line ELi may be variable.

The first to seventh transistors T1 to T7 may be P-type transistors. Each of the first to seventh transistors T1 to T7 may be a metal oxide silicon field effect transistor (MOSFET). However, embodiments according to the present disclosure are not limited to this. For example, at least one of the first to seventh transistors T1 to T7 may be replaced by an N-type transistor.

The light emitting element LD may include an anode electrode AE, a cathode electrode CE, and a light emitting layer. The light emitting layer may be located between the anode electrode AE and the cathode electrode CE. The data signal carried via the j-th data line DLj may be stored in the capacitor CP. The fourth transistor T4 may be turned on when the light emission control signal of the first sub-emission control line SEL1 is enabled to a low level. Depending on the voltage of the second node N2 or the gate-source voltage difference of the first transistor T1, the first transistor T1 may regulate the amount of current flowing from the first power

supply voltage node VDDN to the second power supply voltage node VSSN. The light emitting element LD may emit light according to the amount of current flowing.

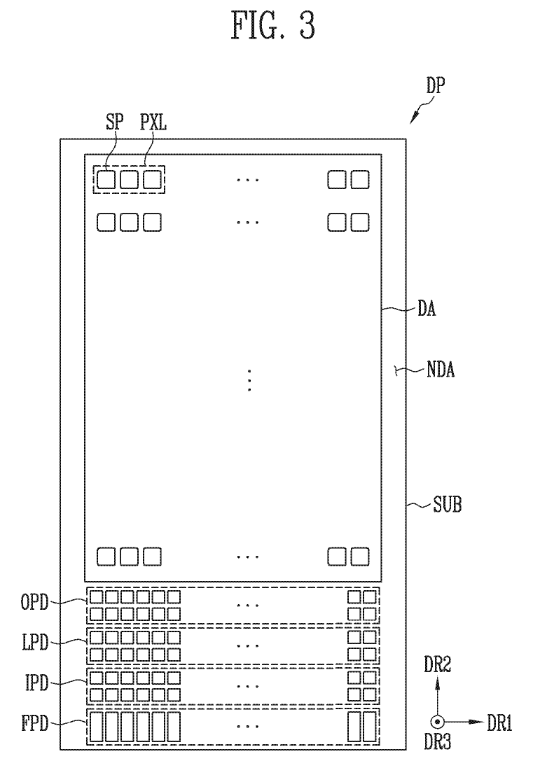

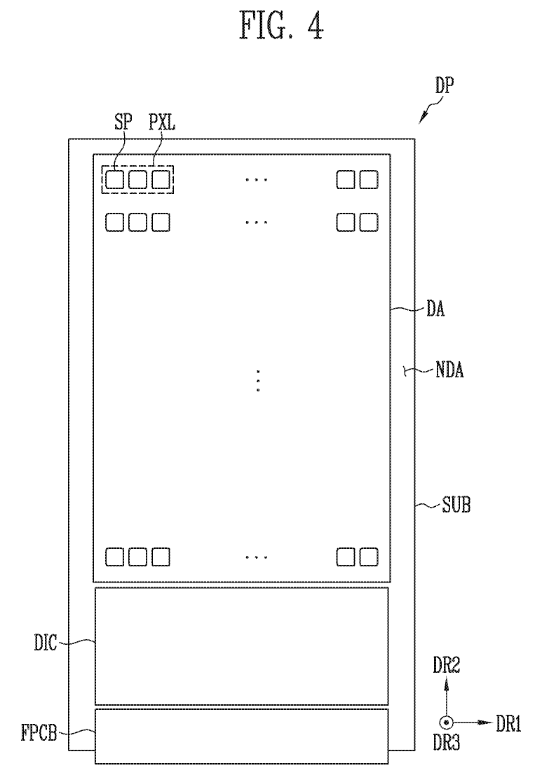

FIG. 3 is a plane view illustrating aspects of the display panel of FIG. 1 according to some embodiments. FIG. 4 is a plane view illustrating embodiments with a driver integrated circuit and circuit board attached to the display panel.

Referring to FIG. 3, the display panel DP may include a display area DA and a non-display area NDA. The display panel DP displays images through the display area DA. The non-display area NDA is arranged around the periphery (e.g., surrounding or outside a footprint) of the display area DA, and images may not be shown in the non-display area NDA.

The display panel DP may include a substrate SUB, sub-pixels SP, and pads OPD, LPD, IPD, FPD.

When the display panel DP is used as a display screen for a head-mounted display (HMD), virtual reality (VR) device, mixed reality (MR) device, augmented reality (AR) device, etc., the display panel DP can be positioned very close to the user's eyes. In such cases, a relatively high density of sub-pixels SP is required. To increase the integration of the sub-pixels SP, the substrate SUB may be provided as a silicon substrate. On the substrate SUB, which is a silicon substrate, the sub-pixels SP and/or the display panel DP may be formed. The display device 100 (see FIG. 1) including the display panel DP formed on the substrate SUB, which is a silicon substrate, may be referred to as an OLED on silicon (OLEDoS) display device.

The sub-pixels SP are located in a display area DA on the substrate SUB. The sub-pixels SP may be arranged in a matrix form or arrangement of rows and columns arranged along a first direction DR1 and a second direction DR2 intersecting the first direction DR1. However, embodiments are not limited to this. For example, the sub-pixels SP may be arranged in a zigzag pattern along the first direction DR1 and the second direction DR2. For example, the sub-pixels SP may be

arranged in a pentile PENTILE^{TM} configuration. The first direction DR1 may be in the row direction and the second direction DR2 may be in the column direction.

Two or more of the plurality of sub-pixels SP may configure a single pixel PXL.

In the non-display area NDA on the substrate SUB, components for controlling the sub-pixels SP may be located. For example, wiring associated with the sub-pixels SP, such as the first through m-th gate lines GL1 through GLm and the first through n-th data lines DL1 through DLn of FIG. 1, may be located in the non-display area NDA.

At least one of the first or second gate drivers 121, 122, the data driver 130, the voltage generator 140, the controller 150, or the temperature sensor of FIG. 1 may be integrated in the non-display area NDA of the display panel DP. According to some embodiments, the first and second gate drivers 121, 122 of FIG. 1 may be mounted on the display panel DP but located in the non-display area NDA. According to some embodiments, the first and second gate drivers 121, 122 may be implemented as integrated circuits separate from the display panel DP. According to some embodiments, a temperature sensor may be located in the non-display area NDA to sense the temperature of the display panel DP.

The pads OPD, LPD, IPD, FPD are located in the non-display area NDA on the substrate SUB. The pads OPD, LPD, IPD, FPD may include a conductive material. For example, the input/output pad unit 160 of FIG. 1 may include pads OPD, LPD, IPD, and FPD. For example, the test pad unit 170 in FIG. 1 may include illumination pads LPD.

The external input pads FPD may be located outside of the non-display area NDA. For example, the external input pads FPD may be arranged in a first direction DR1.

Referring to FIG. 4, terminals (or, bumps) of the circuit board FPCB may be electrically connected to at least some of the external input pads FPD using a

conductive adhesive member, such as an anisotropic conductive film. The circuit board FPCB may be a flexible printed circuit board or flexible film having a flexible material.

The input pads IPD can be positioned in the second direction DR2 from the external input pads FPD. The input pads IPD may be arranged in the first direction DR1. As shown, the input pads IPD may include a plurality of rows. The input pads IPD may be spaced apart from the output pads OPD.

The external input pads FPD and the input pads IPD may be connected to each other via conductive lines inside the substrate SUB. Thus, electrical signals (e.g., current, voltage) received from the circuit board FPCB may be passed through the external input pads FPD to the input pads IPD. For example, the circuit board FPCB may be electrically coupled to a processor.

The output pads OPD may be located in the second direction DR2 from the input pads IPD. The output pads OPD may be arranged in the first direction DR1. As shown, the output pads OPD may include a plurality of rows. The output pads OPD may be located adjacent to the pixels PXL.

The illumination pads LPD may be located between the output pads OPD and the input pads IPD. The illumination pads LPD may be arranged in a first direction DR1. As shown, the illumination pads LPD may include a plurality of rows. The illumination pads LPD may be provided for the purpose of verifying normal operation of the display panel DP prior to attaching the driver integrated circuit DIC to the display panel DP. For example, the illumination pads LPD may be contacted with a probe for applying an illumination signal and an illumination test may be performed by applying a test signal through the probe to the display panel DP.

Referring to FIG. 4, the terminals (or, bumps) of the driver integrated circuit DIC may be electrically connected to at least some of the input pads IPD and at least some of the output pads OPD using a conductive adhesive material, such as an anisotropic conductive film. The driver integrated circuit DIC may cover the

illumination pads IPD. According to some embodiments, the driver integrated circuit DIC may include terminals (or, bumps) that may be electrically connected to the illumination pads IPD.

The driver integrated circuit DIC may communicate with the electronic device's processor or other components of the display device via input pads IPD, external input pads FPD, and a circuit board FPCB. The driver integrated circuit DIC may control the display panel DP through the output pads OPD.

According to some embodiments, the illumination pads LPD are not cut after the lighting inspection, thus preventing or reducing cracking of the display panel DP due to cutting. Further, by covering the exposed illumination pads LPD with a driver integrated circuit DIC, static electricity generation may be prevented or reduced.

According to some embodiments, the display area DA may have various shapes. The display area DA may have the shape of a closed loop including straight and/or curved sides. For example, the display area DA may have the shape of a polygon, circle, semicircle, ellipse, or the like.

According to some embodiments, the display panel DP may have a flat display surface. According to some embodiments, the display panel DP may have a display surface that is at least partially rounded. According to some embodiments, the display panel DP may be bendable, foldable, or rollable. In such cases, the display panel DP and/or the substrate SUB may include materials having flexible properties.

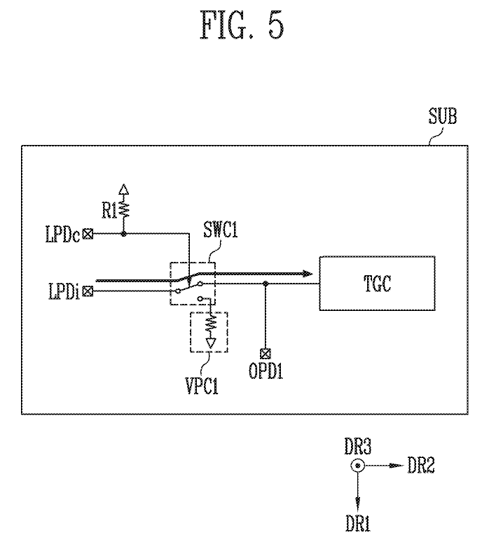

FIGS. 5 and 6 are drawings to illustrate the relationship between an illumination input pad, an illumination control pad, and a first output pad, according to some embodiments of the present invention.

Referring to FIG. 5, a display device according to some embodiments of the present disclosure may include a first switch circuit SWC1, a first voltage providing circuit VPC1, and a first resistor R1. The first switch circuit SWC1, the first

voltage providing circuit VPC1, and the first resistor R1 may be located on a substrate SUB.

The illumination pads LPD may include an illumination control pad LPDc and an illumination input pad LPDi. For example, the illumination pads LPD may include a single illumination control pad LPDc and a plurality of illumination input pads LPDi. The display device may include a plurality of first switch circuits SWC1 corresponding to the number of the plurality of illumination input pads LPDi. According to some embodiments, one illumination control pad LPDc may control the plurality of first switch circuits SWC1 simultaneously.

The output pads OPD may include a first output pad OPD1. In FIGS. 5 and 6, only one first output pad OPD1 is shown for illustration, but the output pads OPD may include other similarly configured output pads.

The first resistor R1 may be coupled to the illumination control pad LPDi. For example, the first resistor R1 may be a pull- down resistor connected to a ground terminal or a low voltage source.

The first voltage providing circuit VPC1 may provide a first voltage. The first voltage may be set to a ground voltage or a low voltage for a pull-down purpose. According to some embodiments, the first voltage may be set to a high voltage, a specific voltage, or otherwise, depending on the purpose.

The first switch circuit SWC1 may be connected to the illumination control pad LPDc, the illumination input pad LPDi, the first voltage providing circuit VPC1, and the first output terminal OPD1. The first switch circuit SWC1 may switch an electrical path based on a signal from the illumination control pad LPDc.

According to some embodiments, the first switch circuit SWC1 may connect the illumination input pad LPDi with the first output pad OPD1 or connect the illumination input pad LPDi with the first voltage providing circuit VPC1 based on a signal applied to the illumination control pad LPDc.

For example, when the probe applies a high voltage to the illumination control pad LPDc, the first switch circuit SWC1 may electrically connect the illumination input pad LPDi and the first output pad OPD1 (see FIG. 5). Thus, a signal applied to the illumination input pad LPDi by the probe may be delivered to the first output pad OPD1. The first output pad OPD1 may be connected to a target circuit TGC of the display device. The target circuit TGC may be various circuits of the display device that require electrical signals, such as the gate driver 120, data lines DL1 to DLn connecting to the sub-pixels SP, a demultiplexer for distributing the data signals, and control circuit for controlling the demultiplexer circuit. The signal applied by the probe to the illumination input pad LPDi may be applied to the target circuit TGC, thereby performing an illumination test of the display device.

After the illumination test is performed, when the probe is removed from the illumination control pad LPDc, the illumination control pad LPDc is pulled-down through the first resistor R1. For example, a low voltage or a ground voltage may be applied to the illumination control pad LPDc. In this case, the first switch circuit SWC1 may electrically connect the illumination input pad LPDi and the first voltage providing circuit VPC1 (see FIG. 6). Thus, the illumination input pad LPDi may be pulled-down to the first voltage. After then, the attached driver integrated circuit DIC may control the target circuit TGC via the first output pad OPD1.

According to some embodiments, after the lighting test, the exposed illumination pads LPDc, LPDi may be pulled-down to prevent or reduce noise generation or malfunction of the display device.

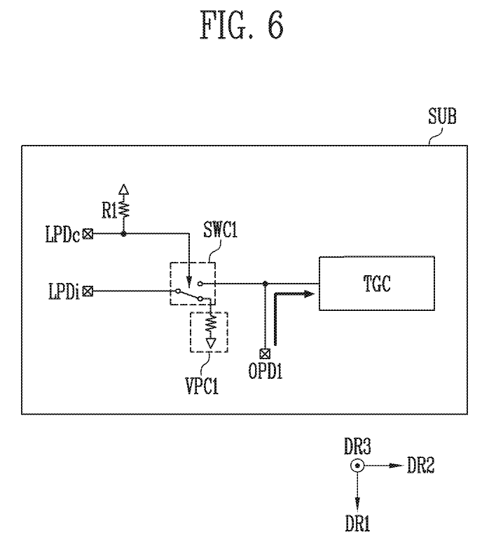

FIG. 7 is a drawing to illustrate aspects of a first switch circuit and a first voltage providing circuit.

Referring to FIG. 7, the first switch circuit SWC1 may include P-type transistors ST1, ST3, ST5, ST7, ST9, ST11 and N-type transistors ST2, ST4, ST6, ST8, ST10, ST12.

Transistor ST1 may have a first electrode receiving a high voltage VDD, a second electrode connected to node N11, and a gate electrode connected to an illumination control pad LPDc.

Transistor ST2 may have a first electrode connected to node N11, a second electrode receiving a low voltage VSS, and a gate electrode connected to the illumination control pad LPDc.

Transistor ST3 may have a first electrode receiving a high voltage VDD, a second electrode connected to node N12, and a gate electrode connected to node N11.

Transistor ST4 may have a first electrode connected to node N12, a second electrode receiving a low voltage VSS, and a gate electrode connected to node N11.

The transistor ST5 may have a first electrode connected to the illumination input pad LPDi, a second electrode connected to the first electrode of the transistor PT4, and a gate electrode connected to the node N12.

The transistor ST6 may have a first electrode connected to the illumination input pad LPDi, a second electrode connected to the first electrode of the transistor PT4, and a gate electrode connected to the node N11.

Transistor ST7 may have a first electrode connected to node N13, a second electrode connected to the first output pad OPD1, and a gate electrode connected to node N11.

Transistor ST8 may have a first electrode connected to node N13, a second electrode connected to the first output pad OPD1, and a gate electrode connected to node N12.

The transistor ST9 may have a first electrode receiving a high voltage VDD, a second electrode connected to the node N14, and a gate electrode connected to the illumination input pad LPDi.

The transistor ST10 may have a first electrode connected to the node N14, a second electrode receiving a low voltage VSS, and a gate electrode connected to the illumination input pad LPDi.

Transistor ST11 may have a first electrode receiving a high voltage VDD, a second electrode connected to node N13, and a gate electrode connected to node N14.

Transistor ST12 may have a first electrode connected to node N13, a second electrode receiving a low voltage VSS, and a gate electrode connected to node N14.

Referring to FIG. 7, the first voltage providing circuit VPC1 may include P-type transistors PT1, PT2 and N-type transistors PT3, PT4. For example, the first voltage provided by the first voltage providing circuit VPC1 may be a low voltage VSS.

Transistor PT1 may have a first electrode receiving a high voltage VDD, a second electrode connected to node N21, and a gate electrode connected to node N21.

Transistor PT2 may have a first electrode receiving a high voltage VDD, a second electrode connected to node N21, and a gate electrode connected to the first electrode of transistor PT4.

Transistor PT4 may have a first electrode connected to the second electrodes of transistors ST5, ST6, a second electrode receiving a low voltage VSS, and a gate electrode connected to node N21.

The transistor PT4 may have a first electrode connected to the gate electrode of the transistor PT2, a second electrode receiving a low voltage VSS, and a gate electrode connected to the node N21.

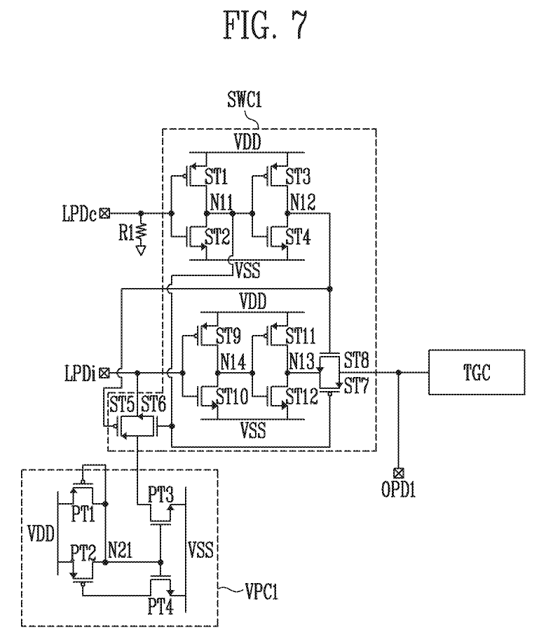

FIG. 8 is a drawing to illustrate the relationship between an illumination input pad, an illumination control pad, a first output pad, a first illumination pad, and a second illumination pad, according to some embodiments of the present invention.

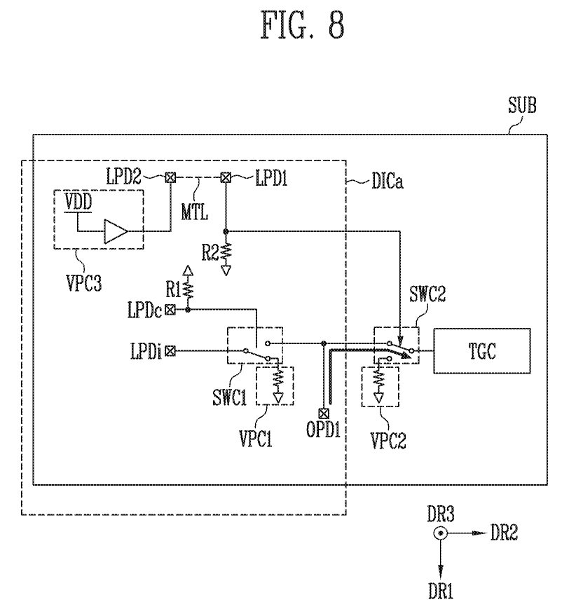

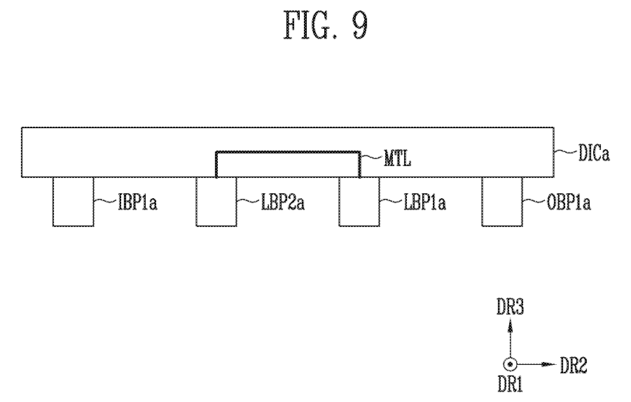

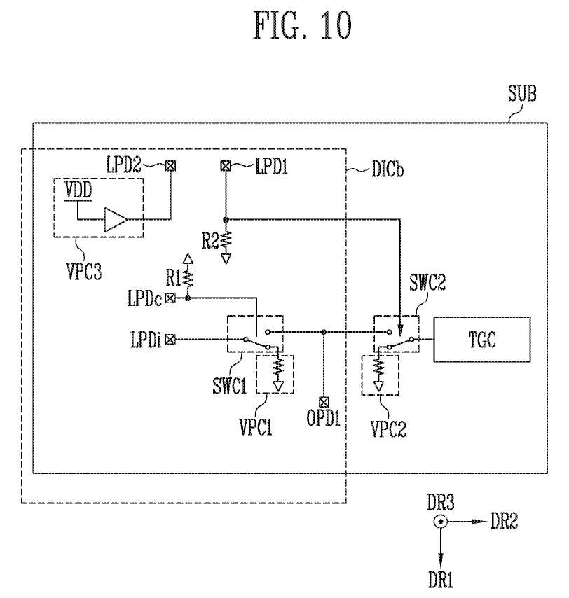

FIG. 9 is a drawing to illustrate a driver integrated circuit according to some embodiments of the present invention. FIG. 10 is a drawing to illustrate the relationship between an illumination input pad, an illumination control pad, a first output pad, a first illumination pad, and a second illumination pad, according to some embodiments of the present invention. FIG. 11 is a drawing to illustrate a driver integrated circuit, according to some embodiments of the present invention.

Referring to FIG. 8, a display device according to some embodiments of the present invention may include a first switch circuit SWC1, a first voltage providing circuit VPC1, a first resistor R1, a second resistor R2, a second voltage providing circuit VPC2, a second switch circuit SWC2, and a third voltage providing circuit VPC3. These configurations may be located on the substrate SUB. In describing FIGS. 8 to 11, some description that is redundant of that described with reference to FIGS. 5 through 7 may be omitted.

The illumination pads LPD may include a first illumination pad LPD1 and a second illumination pad LPD2.

The second resistor R2 may be connected to the first illumination pad LPD1. For example, the second resistor R2 may be a pull-down resistor connected to a ground terminal or a low voltage source.

The second voltage providing circuit VPC2 may provide a second voltage. The second voltage may be set to a ground voltage or a low voltage for pull-down purposes. According to some embodiments, the second voltage may be set to a high voltage, a specific voltage, or otherwise, depending on the purpose.

The second switch circuit SWC2 may be connected to the first output pad OPD1, the first illumination pad LPD1, the second voltage providing circuit VPC2, and the target circuit TGC. The second switch circuit SWC2 may switch an electrical path based on a signal from the first illumination pad LPD1.

According to some embodiments, the second switch circuit SWC2 may connect the target circuit TGC to the first output pad OPD1 or connect the target

circuit TGC to the second voltage providing circuit VPC2 based on a signal applied to the first illumination pad LPD1.

The third voltage providing circuit VPC3 may provide a third voltage to the second illumination pad LPD2. For example, the third voltage may be a high voltage VDD.

The driver integrated circuit DICa may include output terminals electrically connected to at least some of the output pads OPD, input terminals electrically connected to at least some of the input pads IPD, a first illumination terminal LBP1a electrically connected to the first illumination pad LPD1, and a second illumination terminal LBP2a electrically connected to the second illumination pad LPD2 (see FIG. 9). The output terminals of the driver integrated circuit DICa may include an output terminal OBP1a electrically connected to the first output pad OPD1. The input terminals of the driver integrated circuit DICa may include an input terminal IBP1a that is connected to any of the input pads IPD.

According to some embodiments, the driver integrated circuit DICa may include a conductive line MTL connecting the first illumination terminal LBP1a and the second illumination terminal LBP2a. Thus, when the driver integrated circuit DICa is attached to the display panel DP, the second illumination pad LPD2 and the first illumination pad LPD1 may be electrically connected via the second illumination terminal LBP2a, the conductive line MTL, and the first illumination terminal LBP1a (see FIG. 8). At this time, the second switch circuit SWC2, upon receiving the third voltage, may connect the target circuit TGC to the first output pad OPD1. Thus, the target circuit TGC may be activated. The target circuit TGC may be under the control of the driver integrated circuit DICa.

On the other hand, referring to FIG. 11, the driver integrated circuit (DICb) may include terminals (IBP1b, LBP2b, LBP1b, OBP1b) corresponding to those of FIG. 9, but may not include a conductive line (MTL) connecting the first lighting terminal (LBP1b) and the second lighting terminal (LBP2b). In this case, the first

illumination pad LPD1 may be pulled down through the second resistor R2, and the second switch circuit SWC2 may connect the target circuit TGC to the second voltage providing circuit VPC2. Thus, the target circuit TGC may be deactivated. The target circuit TGC may not be under the control of the driver integrated circuit DICb.

According to some embodiments, the illumination pads LPD may be used to enable or disable the target circuit TGC for driver integrated circuits DICa, DICb with different functions by different manufacturers. In other words, one type of display panel DP may be used to be compatible with different types of driver integrated circuits DICa, DICb. According to some embodiments, the illumination pads LPD may also be useful after the illumination inspection.

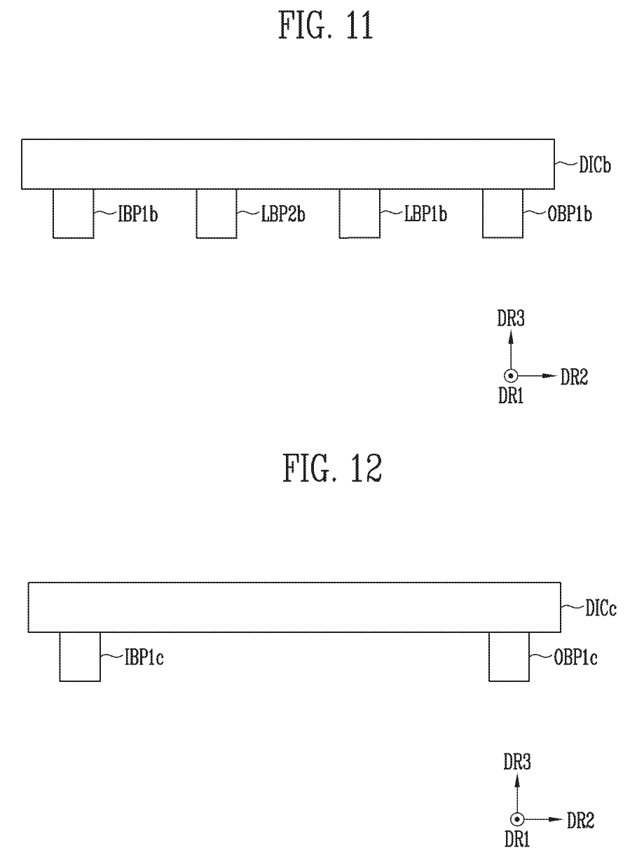

FIG. 12 is a drawing to illustrate a driver integrated circuit according to some embodiments of the present invention.

The driver integrated circuit DICc of FIG. 12 may include output terminals electrically connected to at least some of the output pads OPD and input terminals electrically connected to at least some of the input pads IPD. The output terminals of the driver integrated circuit DICc may include output terminals OBP1c electrically connected to the first output pad OPD1. The input terminals of the driver integrated circuit DICc may include input terminals IBP1c that are connected to any of the input pads IPDs.

The driver integrated circuit DICc may not include terminals corresponding to the illumination pads LPD. In this case, as with the driver integrated circuit DICb in FIG. 11, the function of the target circuit TGC may be disabled. In other words, the driver integrated circuit DICc without terminals corresponding to the illumination pads LPD may be compatible with the display panel DP according to some embodiments.

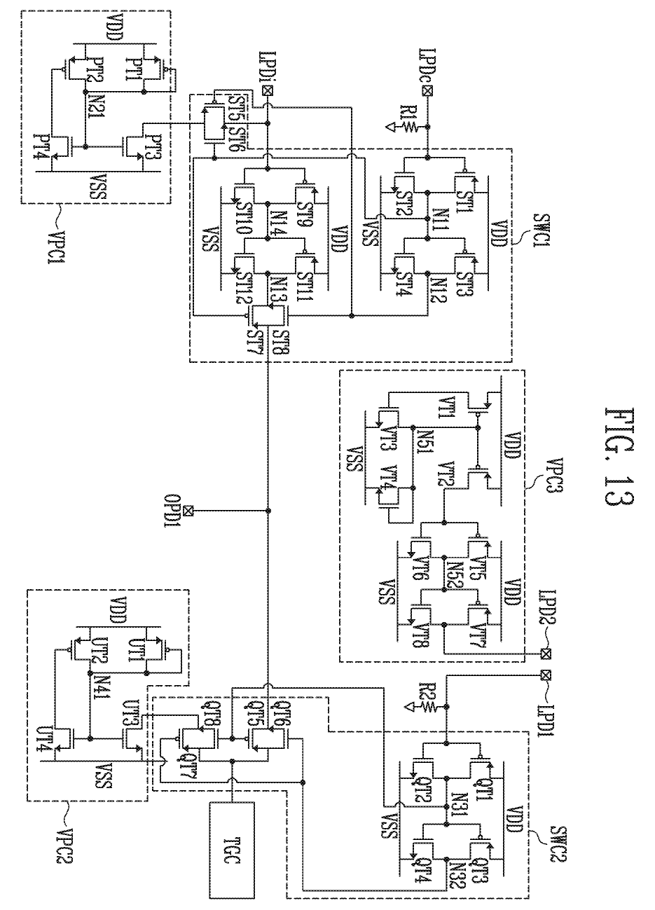

FIG. 13 is a drawing to illustrate aspects of a second switch circuit, a second voltage providing circuit, and a third voltage providing circuit according to some embodiments. The first switch circuit SWC1 and the first voltage providing

circuit VPC1 are the same as described with reference to FIG. 7, and will not be described redundantly.

Referring to FIG. 13, the second switch circuit SWC2 may include P-type transistors QT1, QT3, QT5, and QT7 and N-type transistors QT2, QT4, QT6, and QT8.

Transistor QT1 may have a first electrode receiving a high voltage VDD, a second electrode connected to node N31, and a gate electrode connected to first illumination pad LPD1.

Transistor QT2 may have a first electrode connected to node N31, a second electrode receiving a low voltage VSS, and a gate electrode connected to the first illumination pad LPD1.

Transistor QT3 may have a first electrode receiving a high voltage VDD, a second electrode connected to node N32, and a gate electrode connected to node N31.

Transistor QT4 may have a first electrode connected to node N32, a second electrode receiving a low voltage VSS, and a gate electrode connected to node N31.

Transistor QT5 may have a first electrode connected to the first output pad OPD1, a second electrode connected to the target circuit TGC, and a gate electrode connected to node N31.

Transistor QT6 may have a first electrode connected to the first output pad OPD1, a second electrode connected to the target circuit TGC, and a gate electrode connected to node N32.

The transistor QT7 may have a first electrode connected to the first electrode of the transistor UT3, a second electrode connected to the target circuit TGC, and a gate electrode connected to the node N32.

The transistor QT8 may have a first electrode connected to the first electrode of the transistor UT3, a second electrode connected to the target circuit TGC, and a gate electrode connected to the node N31.

Referring to FIG. 13, the second voltage providing circuit VPC2 may include P-type transistors UT1, UT2 and N-type transistors UT3, UT4. The second voltage may be a low voltage VSS.

Transistor UT1 may have a first electrode receiving a high voltage VDD, a second electrode connected to node N41, and a gate electrode connected to node N41.

Transistor UT2 may have a first electrode receiving a high voltage VDD, a second electrode connected to node N41, and a gate electrode connected to the first electrode of transistor UT4.

Transistor UT3 may have a first electrode connected to the first electrodes of transistors QT7, QT8, a second electrode receiving a low voltage VSS, and a gate electrode connected to node N41.

Transistor UT4 may have a first electrode connected to a gate electrode of transistor UT2, a second electrode receiving a low voltage VSS, and a gate electrode connected to node N41.

Referring to FIG. 13, the third voltage providing circuit VPC3 may include P-type transistors VT1, VT2, VT5, VT7 and N-type transistors VT3, VT4, VT6, VT8. The third voltage may have a higher voltage level than the second voltage. For example, the third voltage may be a high voltage VDD.

The transistor VT1 may have a first electrode receiving the high voltage VDD, a second electrode connected to the gate electrode of the transistor VT3, and a gate electrode connected to the node N51.

Transistor VT2 may have a first electrode receiving a high voltage VDD, a second electrode connected to the gate electrodes of transistors VT5, VT6, and a gate electrode connected to node N51.

Transistor VT3 may have a first electrode connected to node N51, a second electrode receiving a low voltage VSS, and a gate electrode connected to the second electrode of transistor VT1.

Transistor VT4 may have a first electrode connected to node N51, a second electrode receiving the low voltage VSS, and a gate electrode connected to node N51.

Transistor VT5 may have a first electrode receiving a high voltage VDD, a second electrode connected to node N52, and a gate electrode connected to the second electrode of transistor VT2.

Transistor VT6 may have a first electrode connected to node N52, a second electrode receiving a low voltage VSS, and a gate electrode connected to the second electrode of transistor VT2.

Transistor VT7 may have a first electrode receiving a high voltage VDD, a second electrode connected to the second illumination pad LPD2, and a gate electrode connected to node N52.

The transistor VT8 may have a first electrode connected to the second illumination pad LPD2, a second electrode receiving a low voltage VSS, and a gate electrode connected to the node N52.

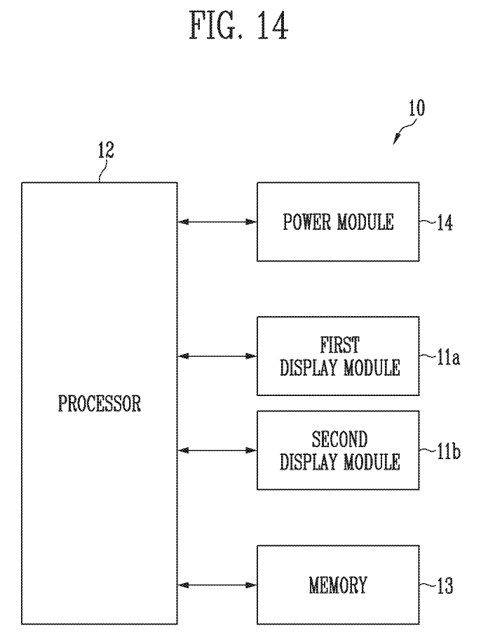

FIG. 14 is a block diagram of an electronic device according to some embodiments.

Referring to FIG. 14, the electronic device 10 may include first and second display modules 11a, 11b, a processor 12, a memory 13, and a power module 14.

The processor 12 may include at least one of a central processing unit (CPU), an application processor (AP), a graphics processing unit (GPU), a communication processor (CP), an image signal processor (ISP), or a controller.

The memory 13 may store data required for operation of the processor 12 or the first and second display modules 11a, 11b. When the processor 12 executes an application stored in the memory 13, image data and control signals are delivered

to the first and second display modules 11a, 11b. The first and second display modules 11a, 11b may process the received image data and control signals and output image information through their display portions.

The power module 14 may include a power supply module, such as a power adapter or battery unit, and a power conversion module that converts the power supplied by the power supply module to generate the power required for operation of the electronic device 10.

In FIG. 14, the electronic device 10 is shown to include first and second display modules 11a, 11b. However, embodiments are not limited thereto, and the electronic device 10 may include one display module or three or more display modules.

At least one of the above-described configurations of the electronic device 10 may be included within the display device according to the above-described embodiments. Furthermore, some of the individual modules that are functionally included within one module may be included within the display device and others may be provided separately from the display device. For example, the display device may include first and second display modules 11a, 11b, while the processor 12, memory 13, and power module 14 may be provided in the form of another device within the electronic device 10 other than the display device. For example, a display device according to the embodiments described above may be provided as each of the first and second display modules 11a, 11b.

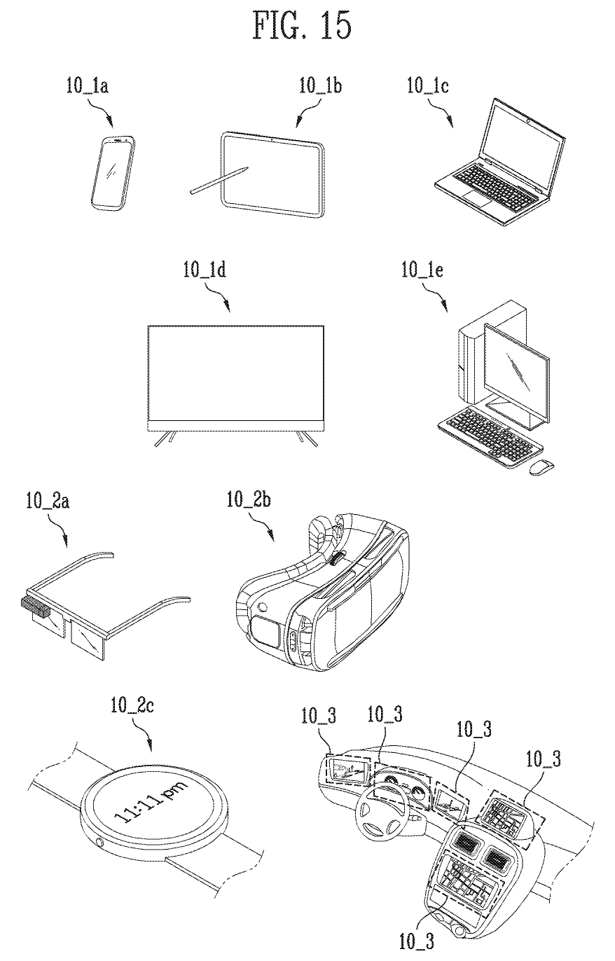

FIG. 15 is a set of drawings illustrating embodiments of electronic devices.

Referring to FIG. 15, various electronic devices with display devices according to embodiments may include electronic devices for displaying images, such as smartphones 10_1a, tablet PCs 10_1b), laptops 10_1c, televisions 10_1d, desk monitors 10_1e, as well as wearable electronic devices including display modules such as smart glasses 10_2a, head-mounted displays 10_2b, smart watches 10_2c, and automotive electronic devices 10_3 including display modules

such as a dashboard of a car, center fascia, center information displays (CID) located on the dashboard, room mirror displays, and the like.

When the electronic device is implemented as a head-mounted display 10_2b, the head-mounted display 10_2b may include first and second display modules 11a, 11b, as described with reference to FIG. 14. The first display module 11a may provide an image to the user's right eye, and the second display module 11b may provide an image to the user's left eye. In such cases, the head-mounted display 10_2b may further include a right-eye lens configured to refract light from the first display module 11a toward the right eye of the user, and a left-eye lens configured to refract light from the second display module 11b toward the left eye of the user. According to some embodiments, each of the right eye lens and the left eye lens may include an optical lens having a pancake-shaped cross-section. According to some embodiments, each of the right eye lens and the left eye lens may include a multi-channel lens including sub-areas having different optical properties. In such a case, each display panel may output images corresponding to each of the sub-areas of the multi-channel lens, and the output images may be displayed to the user through each of the sub-areas.

Display devices and electronic devices including the same according to some embodiments the present invention may include illumination pads that may be utilized without being cut after an illumination test.

Although aspects of some embodiments and applications of embodiments according to the present disclosure have been described herein, other embodiments and variations may be derived from the above description. Accordingly, the spirit and scope of embodiments according to the present invention is not limited to these embodiments, but extends to the patent claims, and equivalents set forth below.

What is claimed is:

1. A display device comprising:
pixels;
output pads adjacent to the pixels;
input pads spaced apart from the output pads;
illumination pads between the output pads and the input pads, and comprising an illumination control pad and an illumination input pad;
a first resistor connected to the illumination control pad;
a first voltage providing circuit configured to provide a first voltage; and
a first switch circuit configured to, based on a signal applied to the illumination control pad, connect the illumination input pad to a first output pad of the output pads, or connect the illumination input pad to the first voltage providing circuit.

2. The display device of claim 1,
wherein, based on the first switch circuit connecting the illumination input pad to the first voltage providing circuit, the illumination control pad is configured to be in a pulled-down state through the first resistor.

3. The display device of claim 1, further comprising:
a driver integrated circuit electrically connected to at least some of the output pads and at least some of the input pads, and covering the illumination pads.

4. The display device of claim 1,
wherein the illumination pads further comprise a first illumination pad,
further comprising:
a second resistor connected to the first illumination pad;
a second voltage providing circuit configured to provide a second voltage; and
a second switch circuit configured to, based on a signal applied to the first illumination pad, connect a target circuit to the first output pad, or connect the target circuit to the second voltage providing circuit.

5. The display device of claim 4,
wherein the illumination pads further comprise a second illumination pad,
further comprising:
a third voltage providing circuit configured to provide a third voltage to the second illumination pad.

6. The display device of claim 5,
wherein, based on the second switch circuit connecting the target circuit to the second voltage providing circuit, the first illumination pad is configured to be in a pulled-down state through the second resistor.

7. The display device of claim 5, further comprising:
a driver integrated circuit comprising output terminals electrically connected to at least some of the output pads, input terminals electrically connected to at least some of the input pads, a first illumination terminal electrically connected to the first illumination pad, and a second illumination terminal electrically connected to the second illumination pad.

8. The display device of claim 7,
wherein the driver integrated circuit further comprises a conductive line connecting the first illumination terminal and the second illumination terminal.

9. The display device of claim 8,
wherein the second illumination pad and the first illumination pad are electrically connected via the second illumination terminal, the conductive line, and the first illumination terminal.

10. The display device of claim 9,
wherein, when the second illumination pad and the first illumination pad are electrically connected, the first output terminal is connected to the target circuit via the second switch circuit.

11. An electronic device comprising:
a processor configured to provide image data; and
a display device configured to display an image based on the image data,
wherein the display device comprises:
pixels;
output pads adjacent to the pixels;
input pads spaced apart from the output pads;
illumination pads between the output pads and the input pads, and comprising an illumination control pad and an illumination input pad;
a first resistor connected to the illumination control pad;
a first voltage providing circuit configured to provide a first voltage; and
a first switch circuit configured to, based on a signal applied to the illumination control pad, connect the illumination input pad to a first output pad of the output pads, or connect the illumination input pad to the first voltage providing circuit.

12. The electronic device of claim 11,
wherein, based on the first switch circuit connecting the illumination input pad to the first voltage providing circuit, the illumination control pad is configured to be in a pulled-down state through the first resistor.

13. The electronic device of claim 11,
wherein the display device further comprises:
a driver integrated circuit electrically connected to at least some of the output pads and at least some of the input pads, and covering the illumination pads.

14. The electronic device of claim 11,
wherein the illumination pads further comprise a first illumination pad,
wherein the display device further comprises:
a second resistor connected to the first illumination pad;
a second voltage providing circuit configured to provide a second voltage; and
a second switch circuit configured to, based on a signal applied to the first illumination pad, connect a target circuit to the first output pad, or connect the target circuit to the second voltage providing circuit.

15. The electronic device of claim 14,
wherein the illumination pads further comprise a second illumination pad,
wherein the display device further comprises:
a third voltage providing circuit configured to provide a third voltage to the second illumination pad.

16. The electronic device of claim 15,
wherein, based on the second switch circuit connecting the target circuit to the second voltage providing circuit, the first illumination pad is configured to be in a pulled-down state through the second resistor.

17. The electronic device of claim 15,
wherein the display device further comprises:
a driver integrated circuit comprising output terminals electrically connected to at least some of the output pads, input terminals electrically connected to at least some of the input pads, a first illumination terminal electrically connected to the first illumination pad, and a second illumination terminal electrically connected to the second illumination pad.

18. The electronic device of claim 17,
wherein the driver integrated circuit further comprises a conductive line connecting the first illumination terminal and the second illumination terminal.

19. The electronic device of claim 18,
wherein the second illumination pad and the first illumination pad are electrically connected via the second illumination terminal, the conductive line, and the first illumination terminal.

20. The electronic device of claim 19,
wherein, based on the second illumination pad and the first illumination pad being electrically connected, the first output terminal is configured to be connected to the target circuit via the second switch circuit.
